(19) United States
(12) Patent Application Publication
(10) Pub. No.: US 2012/0050469 A1
(43) Pub. Date: Mar. 1, 2012

(54) IMAGE PROCESSING DEVICE, IMAGE PROCESSING METHOD AND IMAGE PROCESSING SYSTEM

(75) Inventor: Masaaki Takesue, Tokyo (JP)

(73) Assignee: SONY CORPORATION, Tokyo (JP)

(21) Appl. No.: 13/212,481

(22) Filed: Aug. 18, 2011

(30) Foreign Application Priority Data
Aug. 27, 2010 (JP) P2010-190924

(51) Int. Cl. H04N 13/00

(52) U.S. Cl. 348/43; 348/E13.003

(57) ABSTRACT

An image processing device of present invention includes a characteristic value extracting unit which receives an input of video data forming a plurality of three dimensional images, and extracts a characteristic value indicating a position of each three dimensional image in a depth direction, and a characteristic value correcting unit which corrects the characteristic value to make stereoscopic effects of the plurality of three dimensional images uniform.

### CROSS-REFERENCE TO RELATED APPLICATION

The present application claims priority from Japanese Patent Application No. JP 2010-190924 filed in the Japanese Patent Office on Aug. 27, 2010, the entire content of which is incorporated herein by reference.

### BACKGROUND

The present disclosure relates to an image processing device, an image processing method and an image processing system.

Recently, display devices which display three dimensional images are widely spreading. A three dimensional image display device is configured to independently transmit two different video signals to left and rights eyes using spatial and temporal methods, and enables recognition of three dimensional images by reproducing the disparity according to the video signals independently transmitted to the left and right eyes. Following Japanese Patent Application Laid-Open No. 2009-239388, Japanese Patent Application Laid-Open No. 2009-239389 and Japanese Patent Application Laid-Open No. 2010-66754 disclose techniques of reducing a sense of fatigue of users who have stereoscopic views when displaying three dimensional images.

### SUMMARY

However, although various schemes of transmitting video images independently to the left and right eyes have been devised, the degree of a stereoscopic effect (depth effect) is significantly influenced by the degree of the disparity. Particularly, when a plurality of three dimensional images are displayed at the same time, stereoscopic effects of the respective three dimensional images may be different. This is because, for example, the difference in the disparity amount between left and right images varies between a plurality of individual video images due to the difference in environment in which video images are created. The difference in the disparity amounts between a plurality of three dimensional images is recognized by users as the difference between the stereoscopic effects of images, and gives a sense of strangeness to users.

Further, when a plurality of three dimensional images are displayed at the same time, if the user's gaze moves between a plurality of video images of different stereoscopic effects, the user needs to unconsciously adjust focus with respect to each video image, and, as a result, there is an issue that the eyes become tired.

In light of the foregoing, it is desirable to provide a novel and improved image processing device, image processing method and image processing system which enable users to view images without a sense of strangeness when the users view a plurality of three dimensional images.

According to an embodiment of the present invention, there is provided an image processing device includes a characteristic value extracting unit which receives an input of video data forming a plurality of three dimensional images, and extracts a characteristic value indicating a position of each three dimensional image in a depth direction, and a characteristic value correcting unit which corrects the characteristic value to make stereoscopic effects of the plurality of three dimensional images uniform.

In this configuration, the characteristic value correcting unit corrects the characteristic value such that a dynamic range of the characteristic value of each three dimensional image becomes equal.

In this configuration, the characteristic value correcting unit corrects the characteristic value to make equal the dynamic range of the characteristic value of each three dimensional image per frame forming the three dimensional image.

In this configuration, the characteristic value correcting unit corrects the characteristic value to make equal a dynamic range of the characteristic value of each three dimensional image within an arbitrary time.

In this configuration, the characteristic value correcting unit corrects the characteristic value to make equal a maximum value or a minimum value of the characteristic value of each three dimensional image.

In this configuration, the characteristic value correcting unit corrects the characteristic value to make equal a maximum value or a minimum value of the characteristic value of each three dimensional value per frame forming the three dimensional image.

In this configuration, the characteristic value correcting unit corrects the characteristic value to make equal a maximum value or a minimum value of the characteristic value of each three dimensional image within an arbitrary time.

According to another embodiment of the present invention, there is provided an image processing method includes receiving an input of video data forming a plurality of three dimensional images, and extracting a characteristic value indicating a position of each three dimensional image in a depth direction, and correcting the characteristic value to make stereoscopic effects of the plurality of three dimensional images uniform.

According to another embodiment of the present invention, there is provided an image processing system includes a first image processing device and a second image processing device. The first image processing device includes a first characteristic value extracting unit which receives an input of video data forming a three dimensional image, and extracts a first characteristic value indicating a position of the three dimensional image in a depth direction, a first characteristic value correcting unit which corrects the first characteristic value to make a stereoscopic effect uniform with respect to a three dimensional image input to a second image processing device based on a second characteristic value extracted in the second image processing device, and a first controlling unit which acquires information related to the second characteristic value extracted in the second image processing device. The second image processing device includes a second characteristic value extracting unit which receives an input of video data forming a three dimensional image, and extracts a second characteristic value indicating a position of the three dimensional image in a depth direction, a second characteristic value correcting unit which corrects the second characteristic value to make a stereoscopic effect uniform with respect to a three dimensional image input to the first image processing device based on the first characteristic value extracted in the first image processing device; and a second controlling unit which acquires the first characteristic value extracted in the first image processing device.

According to the present disclosure, the user can view video images without a sense of strangeness when the user views a plurality of three dimensional images.

### BRIEF DESCRIPTION OF THE DRAWINGS

FIG. 1 is a schematic diagram illustrating a configuration example of a television receiver according to one embodiment of the disclosure;

FIG. 2 is a schematic diagram for describing a dynamic range, maximum value and minimum value of a Z value; and

FIG. 3 is a schematic diagram illustrating a configuration example of a system having a plurality of television receivers.

### DETAILED DESCRIPTION OF THE EMBODIMENT

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

In addition, description will be made in the following order.
1. Configuration example of television receiver
2. Correction of Z value by Z value correcting unit
3. Configuration example of system having a plurality of television receivers

### 1. Configuration Example of Television Receiver

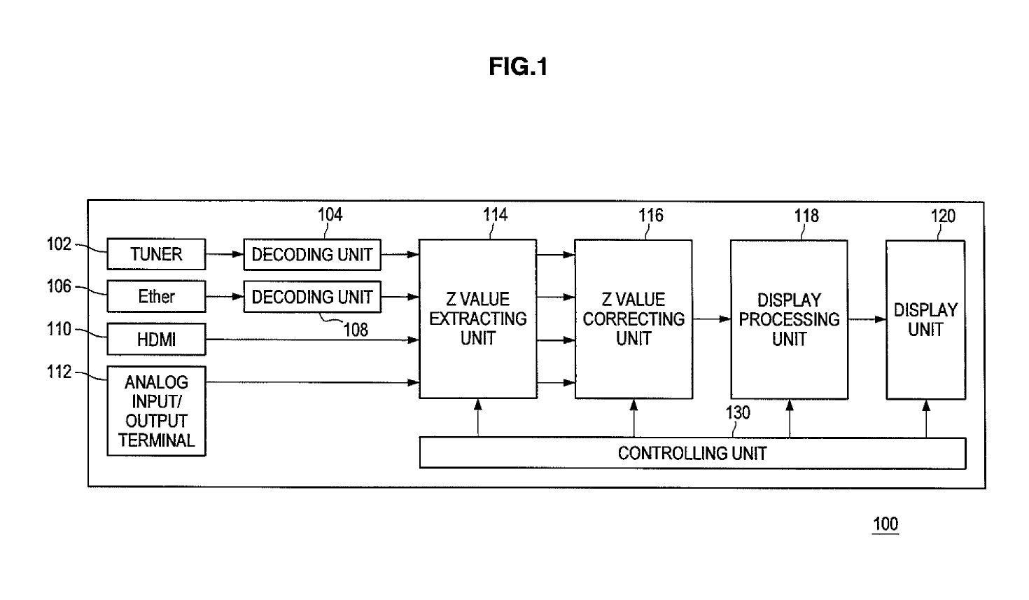

According to the present embodiment, there are provided an image processing device, an image processing method and an image processing system which make stereoscopic effects uniform between a plurality of three dimensional images and which display all three dimensional images with the uniform stereoscopic effect. FIG. 1 is a schematic diagram illustrating a configuration example of a television receiver 100 according to the embodiment of the disclosure. Note that, although a television receiver will be described below, the device according to the present embodiment is by no means limited to the television receiver, and is applicable to devices and systems which enable users to view a plurality of three dimensional images. For example, the device according to the present embodiment may be information processing devices such as personal computers (PC) which display a plurality of three dimensional images and mobile devices such as digital cameras and mobile telephones.

The television receiver 100 illustrated in FIG. 1 has a tuner 102, an Ether input/output terminal 106, an HDMI terminal 110 and an analog input terminal 112 as a plurality of video input terminals. Video sources for a broadcasting system are input through the tuner 102, and video sources for a network system are input through the Ether input/output terminal 106. Further, baseband digital video sources are input through the HDMI terminal 110. Further, analog video sources such as DVD player outputs and video cassette recorder outputs are input through the analog input terminal 112.

A video source input to the tuner 102 is decoded in the decoding unit 104 and is output to a Z value extracting unit 114. Further, a video source input to the Ether input/output terminal 106 is decoded in a decoding unit 108, and is output to the Z value extracting unit 114. By contrast with this, a video source input to the HDMI terminal 110 and video source input to the analog input terminal 112 are directly output to the Z value extracting unit 114. In addition, when 3D broadcasting is performed in analog broadcasting, according to subsequent processing of the tuner 102, an output of the tuner 102 is input to the Z value extracting unit 114 through a path (not illustrated) which does not go through the decoding unit 104.

Although there are various signal formats of three dimensional images, signal formats are assumed for both of a case where the video source input through each input terminal includes information about each pixel in the depth direction and a case where the video source does not include information about each pixel in the depth direction.

In the present embodiment, the amount of this information in the depth direction (characteristic value) is referred to as “Z value”. The Z value extracting unit 114 first extracts Z values from all video sources. The Z values are extracted by extracting and utilizing values accompanying video signals.

Further, when Z values do not accompany video signals, the Z value extracting unit 114 extracts Z values by image analysis. For example, when there are three dimensional video formats for transmitting two types of images for the left eye and right eye, these two images are compared at the pixel level and a pattern is recognized to calculate the disparity amount between pixels and acquire a Z value from the disparity amount. For example, there are corresponding patterns (for example, building and people) in two types of respective images for the left eye and right eye, and therefore the Z value extracting unit 114 calculates the disparity amount (pixel shift amount) of each pattern in two images for the left eye and right eye from these pattern recognition results. Thus, the disparity amounts of all pixels are extracted. The Z value which is the amount of information about a three dimensional image in the depth direction is a value corresponding to the disparity amount, and can be calculated from the disparity amount. Further, the disparity amount may be used as the Z value.

The Z value acquired in this way is input to a Z value correcting unit 116. Although described in detail below, the Z value correcting unit 116 corrects the Z value based on the result of comparing Z values between video signals matching video sources to adjust the difference between the stereoscopic effects of three dimensional image signals.

A display processing unit 118 receives video sources of corrected Z values. The display processing unit 118 calculates the disparity amount of each pixel from the corrected Z value, and performs processing of creating two types of items of video data for the left eye and right eye including the disparity. A display unit 120 has, for example, a liquid crystal display, and provides display based on video data input from the display processing unit 118.

A controlling unit 130 can be configured with a central processing unit (CPU), and controls the components illustrated in FIG. 1. Particularly, the controlling unit 130 compares the Z value extracted in the Z value extracting unit 114 and associated with each video source, and controls correction of the Z value in the Z value correcting unit 116 according to this result. Further, the controlling unit 130 controls generation processing of video data in the display processing unit 118 based on the corrected Z value.

### 2. Correction of Z Value by Z Value Correcting Unit

Next, correction of the Z value in the Z value correcting unit 116 will be described in detail. The Z value correcting unit 116 corrects the Z value according to correcting methods as described in the following (1) to (4).

(1) A distribution of Z values of one frame of three dimensional images at one moment is compared and the Z values are adjusted such that the dynamic range of the distribution becomes equal.

With this method, the dynamic range of the Z value is calculated per video source from the difference between an image positioned on the frontmost side (closest to the viewer) in the depth direction and an image positioned on the deepest side (farthest from the view) in images of one frame. Further, the Z value is corrected such that the dynamic range becomes equal in each video source per frame. By this means, the dynamic ranges of all three dimensional images are adjusted to be equal, so that the user can view a plurality of three dimensional images in a state where all video sources have a uniform stereoscopic effect. Consequently, it is possible to prevent an issue that a stereoscopic effect of a specific video source in the depth direction is emphasized. By this means, it is possible to suppress a sense of strangeness given to the viewer and suppress a sense of fatigue of the viewer.

(2) A distribution of Z values of three dimensional images is studied over a certain period of time (over a plurality of frames), and Z values are adjusted such that the dynamic ranges become equal.

With this method, a distribution of Z values within a certain period of time is acquired per video source, and the Z values are corrected such that the dynamic range of each video source becomes equal within this certain period of time. As one example, the Z values are corrected such that the dynamic range of each video source within a certain period time is corrected to an average value of the dynamic range of each video source within this certain period of time. By this means, it is possible to suppress a rapid change of the dynamic range of a video source which rapidly changes the dynamic range per frame, and provide a plurality of three dimensional images which the viewer can easily view.

(3) A distribution of Z values of three dimensional images in one frame at one moment is compared and Z values are adjusted such that maximum values of the Z values (or minimum values) become equal. With this method, the Z value is corrected such that the maximum value (or minimum value) of each video source per frame becomes equal. When the Z values are corrected such that the maximum values of the Z values become equal, the positions of images positioned on the frontmost side (on the viewer side) per frame become the same in each video source. Consequently, it is possible to prevent images of specific video sources from being displayed on the front side compared to other video sources. Further, when the Z values are corrected such that the minimum values of the Z values become equal, the positions of the images positioned in the deepest side (farthest from the viewer) per frame become the same in each video source. Consequently, it is possible to prevent images of specific video sources from being displayed on the depth side compared to the other video sources. By this means, it is possible to suppress a sense of strangeness given to the viewer and suppress a sense of fatigue of the viewer.

(4) A distribution of Z values of three dimensional images over a certain period of time is studied, and the Z values are adjusted such that the maximum values (or minimum values) of the Z values become equal. With this method, a distribution of Z values within a certain period of time is acquired per video source, and the Z values are corrected such that the maximum values (or minimum values) within this certain period of time become equal. As an example, the Z values are corrected such that the maximum value (or minimum values) of each video source within a certain period of time becomes an average value of the maximum values (or minimum values) in each frame of each video source within this certain period of time. By this means, it is possible to prevent a rapid change of the maximum value (or minimum value) of a video source which significantly changes the maximum value (or minimum value) per frame, and provide a plurality of three dimensional images which the viewer can more easily view. In addition, even in this case, the dynamic ranges of the original sources are kept (maintained), so that it is possible to display images without undermining the depth effect.

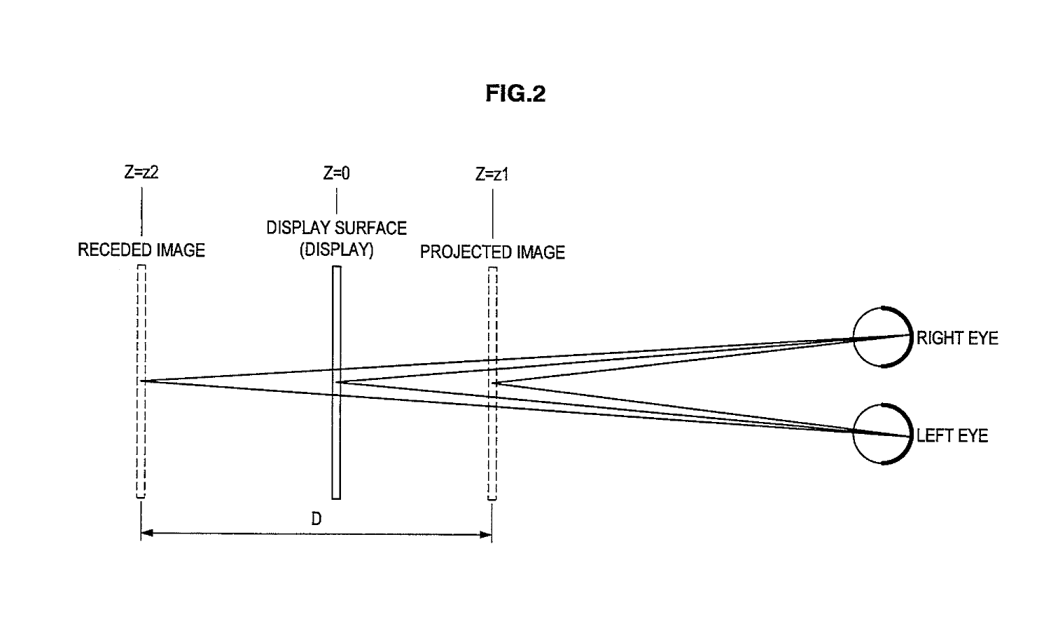

FIG. 2 is a schematic diagram for describing the dynamic range, maximum value and minimum value of the Z value. FIG. 2 is a schematic diagram illustrating receded image which is seemingly displayed in the depth beyond the display surface and a projected image which is seemingly displayed before the display surface with respect to the position of the display surface (display). As illustrated in FIG. 2, the Z value on the display surface is 0. The above dynamic range corresponds to a difference D (=z1−z2) between the Z value (z1(>0)) of a projected image which is seemingly displayed on the frontmost side and the Z value (z2(<0)) of a receded image which is seemingly displayed on the deepest side. The maximum value of the Z value is a value z1 of the Z value of the projected image which is seemingly displayed on the frontmost side, and the minimum value of the Z value is a value z2 of the Z value of a receded image which is seemingly displayed in the deepest side. The projected image which is seemingly displayed on the frontmost side provides the maximum disparity amount, and the receded image which is seemingly displayed in the deepest side provides the minimum disparity amount. Meanwhile, the signs of the maximum disparity amount and minimum disparity amount in this case are opposite. Further, with an image in the position of the display surface, the disparity amount is 0.

According to the above (1) method, the Z value of each video source is corrected such that the dynamic range D which is the difference between the Z value (z2) of the receded image which is seemingly displayed in the deepest side and the Z value (z1) of the projected image which is seemingly displayed on the frontmost side becomes equal between video sources. Consequently, it is possible to make stereoscopic effects of all video sources uniform, suppress a sense of strangeness given to the user and suppress a sense of fatigue of the user's eyes.

Further, according to the method (2), in each frame displayed in a certain period of time, the Z value is corrected such that the dynamic range D is equal between video sources. Consequently, it is possible to make stereoscopic effect of all video sources uniform, prevent a rapid change of the dynamic range and reliably suppress a sense of fatigue of the user's eyes.

Further, according to the method (3), the maximum value z1 or minimum value z2 of the Z value per frame is corrected to be equal between video sources. Consequently, it is possible to align the position of the projected image which is seemingly displayed on the frontmost side and the position of the receded image which is seemingly displayed in the deepest side, suppress a sense of strangeness given to the user and minimize a sense of fatigue of the user's eyes. When the dynamic ranges are made uniform, if, for example, people which are displayed on the front side move in the depth direction, the position of the background in the depth direction is expected to move following the movement of people. However, by correcting the maximum values z1 or minimum values z2 to be equal, it is possible to uniformly align the position of images on the front side or positions of the background on the depth side.

Further, according to the method (4), the maximum values z1 or minimum values z2 of Z values are corrected to be equal between video sources in each frame displayed in a certain period of time. Consequently, it is possible to make stereoscopic effects of all video sources uniform, prevent a rapid change of the maximum values z1 or minimum values z2 of Z values and reliably suppress a sense of fatigue of the user's eyes. As described above, in this case, the dynamic ranges of the original sources are kept (maintained), so that it is possible to display images without undermining the depth effect.

Further, the above methods (1) to (4) may be used alone or in combination. For example, by combining the methods (1) and (3), it is possible to makes uniform the dynamic ranges of three dimensional images in the depth direction, and uniformly control the maximum amount of projection or the maximum amount of recession of three dimensional images.

### 3. Configuration Example of System Having a Plurality of Television Receivers

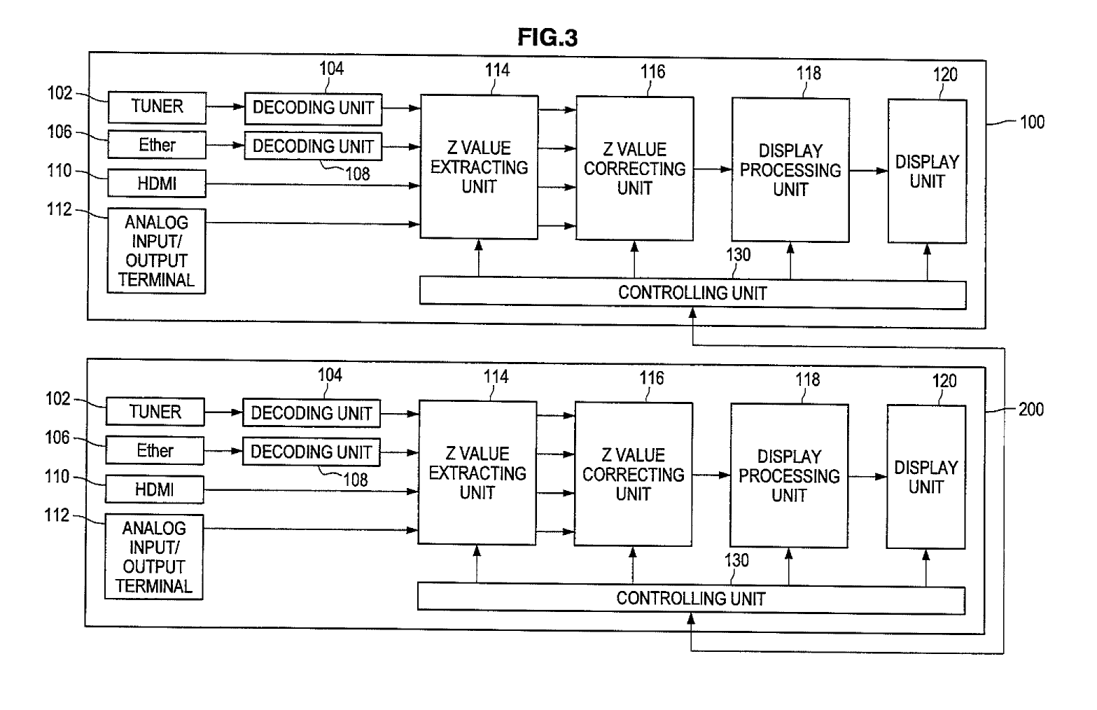

FIG. 3 is a schematic diagram illustrating a configuration example of a system having a plurality of television receivers 100. This system has the television receiver 100 illustrated in FIG. 1, and a television receiver 200 employing the same configuration as the television receiver 100.

As illustrated in FIG. 3, the controlling unit 130 of the television receiver 100 and the controlling unit 130 of the television receiver 200 are connected with each other. This connection may be wired or wireless. By this means, the controlling unit 130 of the television receiver 100 and the controlling unit 130 of the television receiver 200 can transmit and receive information to and from each other.

With the configuration illustrated in FIG. 3, the controlling unit 130 of the television receiver 100 acquires a Z value of each video source from the Z value extracting unit 114. Further, the controlling unit 130 of the television receiver 200 also acquires the Z value of each video source from the Z value extracting unit 114. The controlling units 130 of the television receiver 100 and television receiver 200 communicate with each other, and acquire Z values of all video resources input to both of the television receiver 100 and television receiver 200. Further, the controlling units 130 of the television receiver 100 and television receiver 200 control correction processing of the Z value correcting unit 116 based on the Z values of all video sources according to the above methods (1) to (4) or combination of these.

By this means, it is possible to make uniform the stereoscopic effects of all three dimensional images displayed on both of the television receiver 100 and television receiver 200. Consequently, the user who views both of the television receiver 100 and television receiver 200 do not have a sense of strangeness when the user moves the gaze from images of one television receiver to images of the other television receiver. Further, even when the user moves the gaze from images of one television receiver to images of the other television receiver, the stereoscopic effect of each video source is made uniform, so that the positions to adjust focus of the eyes do not significantly change and, consequently, it is possible to minimize fatigue of the eyes.

As described above, according to the present embodiment, when a three dimensional image display device displays a plurality of three dimensional images at the same time, it is possible to make the stereoscopic effects of all images uniform and provide a natural stereoscopic effect for viewers. Further, when a plurality of images having a uniform stereoscopic effect is displayed and the user moves the gaze between images, the user can focus the eyes on each image by adjusting focus at minimum. Consequently, it is possible to suppress fatigue of the eyes at minimum, and makes it easier to view three dimensional images for a long time.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing device comprising:
a characteristic value extracting unit which receives an input of video data forming a plurality of three dimensional images, and extracts a characteristic value indicating a position of each three dimensional image in a depth direction; and
a characteristic value correcting unit which corrects the characteristic value to make stereoscopic effects of the plurality of three dimensional images uniform.

2. The image processing device according to claim 1,
wherein the characteristic value correcting unit corrects the characteristic value such that a dynamic range of the characteristic value of each three dimensional image becomes equal.

3. The image processing device according to claim 2,
wherein the characteristic value correcting unit corrects the characteristic value to make equal the dynamic range of the characteristic value of each three dimensional image per frame forming the three dimensional image.

4. The image processing device according to claim 2,
wherein the characteristic value correcting unit corrects the characteristic value to make equal a dynamic range of the characteristic value of each three dimensional image within an arbitrary time.

5. The image processing device according to claim 1,
wherein the characteristic value correcting unit corrects the characteristic value to make equal a maximum value or a minimum value of the characteristic value of each three dimensional image.

6. The image processing device according to claim 5,
wherein the characteristic value correcting unit corrects the characteristic value to make equal a maximum value or a minimum value of the characteristic value of each three dimensional value per frame forming the three dimensional image.

7. The image processing device according to claim 5,
wherein the characteristic value correcting unit corrects the characteristic value to make equal a maximum value or a minimum value of the characteristic value of each three dimensional image within an arbitrary time.

8. An image processing method comprising:
receiving an input of video data forming a plurality of three dimensional images, and extracting a characteristic value indicating a position of each three dimensional image in a depth direction; and
correcting the characteristic value to make stereoscopic effects of the plurality of three dimensional images uniform.

9. An image processing system comprising:
a first image processing device including:
a first characteristic value extracting unit which receives an input of video data forming a three dimensional image, and extracts a first characteristic value indicating a position of the three dimensional image in a depth direction;
a first characteristic value correcting unit which corrects the first characteristic value to make a stereoscopic effect uniform with respect to a three dimensional image input to a second image processing device based on a second characteristic value extracted in the second image processing device; and
a first controlling unit which acquires information related to the second characteristic value extracted in the second image processing device; and
the second image processing device including:
a second characteristic value extracting unit which receives an input of video data forming a three dimensional image, and extracts a second characteristic value indicating a position of the three dimensional image in a depth direction;
a second characteristic value correcting unit which corrects the second characteristic value to make a stereoscopic effect uniform with respect to a three dimensional image input to the first image processing device based on the first characteristic value extracted in the first image processing device; and
a second controlling unit which acquires the first characteristic value extracted in the first image processing device.
